(19) United States
(12) Patent Application Publication
(10) Pub. No.: US 2003/0131140 A1
(43) Pub. Date: Jul. 10, 2003

(54) Data transfers in embedded systems

(75) Inventors: Arunabha Ghose, Bangalore (IN); Sumit Dev, Bangalore (IN)

Correspondence Address: TEXAS INSTRUMENTS INCORPORATED, P O BOX 655474, M/S 3999, DALLAS, TX, 75265

(73) Assignee: Texas Instruments Incorporated, Dallas, TX (US)

(21) Appl. No.: 10/256,522

(22) Filed: Sep. 27, 2002

Related U.S. Application Data
(60) Provisional application No. 60/342,091, filed on Dec. 26, 2001.

(51) Int. Cl. G06F 15/163; G06F 9/00

(52) U.S. Cl. 709/310

(57) ABSTRACT

A stack (successive) of non-blocking streams may be used to transfer data from a data source to a user application. For example, one stream may transfer data from a device driver to a random access memory (RAM) and another stream may transfer the data in the RAM to an on-chip memory. By using non-blocking streams, the processing power available in an embedded system may be utilized efficiently. Another aspect of the present invention provides the user applications the ability to control the logic for allocation and release of memory space supporting buffers used in data transfers.

### BACKGROUND OF THE INVENTION

1. Field of the Invention

The present invention relates to embedded systems, and more specifically to a software implemented approach for efficiently transferring data in embedded systems.

2. Related Art

Embedded systems generally refer to specialized systems used to control devices such as automobiles, home and office appliances, and handheld units (e.g, cell phones). The systems typically provide a specific set of utilities (in technology community often referred to as functions) particularly designed for the specific environments in which the systems operate.

Manufacturers of embedded systems often provide interfaces using which applications can be developed customized for the specific environments. In general, it is advantageous if the interface provides flexibility to the application developers in terms of features offered, and yet is efficient in providing the corresponding utility. One common feature needed in embedded systems is transfer of data potentially from external systems.

A prior system may only provide for blocking transfers when an application requires data from an external source. That is, the execution of the application is suspended until the requested data is retrieved from the external source and available for the application. As a result, the applications may be impeded when data transfers are required.

Another prior system may partially overcome such a deficiency by providing non-blocking interfaces. That is, an application requests the transfer of data from an external source and can continue with other tasks while the requested data is retrieved. The transfer request may be made in the form of an interface call. The application later processes the retrieved data at an appropriate time. However, such prior system may provide for only blocking implementations supporting the data transfer interface call. The blocking implementations in turn may lead to inefficiencies in the use of available processing power in an embedded system, and may thus be undesirable.

Accordingly what is needed is a method and apparatus which enables applications to efficiently continue execution when data is required from external sources.

Another desirable feature in embedded systems is providing control over memory management to the application. In some prior systems, a user application can only request (and release) the amount of memory desired and a memory manager allocates the requested memory. The user application generally does not have much control over the allocation of the memory. The allocation approaches can be based on various factors such as minimization of fragmentation, throughput performance, etc. However, the provided approach may not suit the individual application(s) using the memory manager.

Accordingly what is also needed is a method and apparatus which provides additional control to user applications over allocation of memory.

### SUMMARY OF THE INVENTION

According to an aspect of the present invention a stack of non-blocking streams are used in transferring data from a data source to a user application. For example, a user application may generate a issue statement to initiate retrieval of data transfer using a lower non-blocking streaming layer.

The user application may attend to other tasks and then determine whether the requested data is available (for example, using a reclaim statement). The lower non-blocking streaming layer may also operate similarly. In an embodiment, a device driver is implemented in a blocking manner to retrieve data from a data source, a first non-blocking stream may store the retrieved data in a random access memory (RAM), and another non-blocking stream may transfer the data in the RAM into an on-chip memory for use by the user application.

Due to the non-blocking implementation of the data transfer layers, the computation power available within a system may be utilized efficiently.

According to another aspect of the present invention, the user application is provided control over the logic in allocation and release (freeing) of memory space supporting buffers. The buffers are used for transferring data across different layers performing data transfers. By providing control over memory management to the user applications, the available memory may be utilized efficiently.

Further features and advantages of the invention, as well as the structure and operation of various embodiments of the invention, are described in detail below with reference to the accompanying drawings. In the drawings, like reference numbers generally indicate identical, functionally similar, and/or structurally similar elements. The drawing in which an element first appears is indicated by the leftmost digit(s) in the corresponding reference number.

### BRIEF DESCRIPTION OF THE DRAWINGS

The present invention will be described with reference to the accompanying drawings, wherein:

FIG. 1 is a block diagram of the details of a computer system illustrating an example environment in which the present invention can be implemented;

FIG. 2A is a diagram illustrating the manner in which a stack of non-blocking streams can be used to provide efficient data transfers to user applications;

FIG. 2B contains example user application code illustrating the manner in which stack of streams can be generated to transfer data from a data source; and

FIG. 3 contains example user application code illustrating the manner in which user applications may be provided control over the memory allocation according to a feature of the present invention.

### DETAILED DESCRIPTION OF THE PREFERRED EMBODIMENTS

1. Overview and Discussion of the Invention

According to an aspect of the present invention, a user application can make a non-blocking streaming call to retrieve data from an external source. The non-blocking streaming call can in turn be implemented using a non-blocking stream. Thus, a stack (successive) of streams can be used to provide desired data to user applications. Due to the implementation of stack of streams, the processing power in an embedded system can be utilized efficiently while performing data transfers.

According to another feature of the present invention, a user application is provided the ability to control allocation of memory space. The entire available memory is partitioned into multiple spaces, and a different memory manager may be associated with each space. The use application can be written to interface with the different memory managers to have the necessary memory space allocated.

The invention is described with reference to example environments for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the invention.

2. Typical Environment

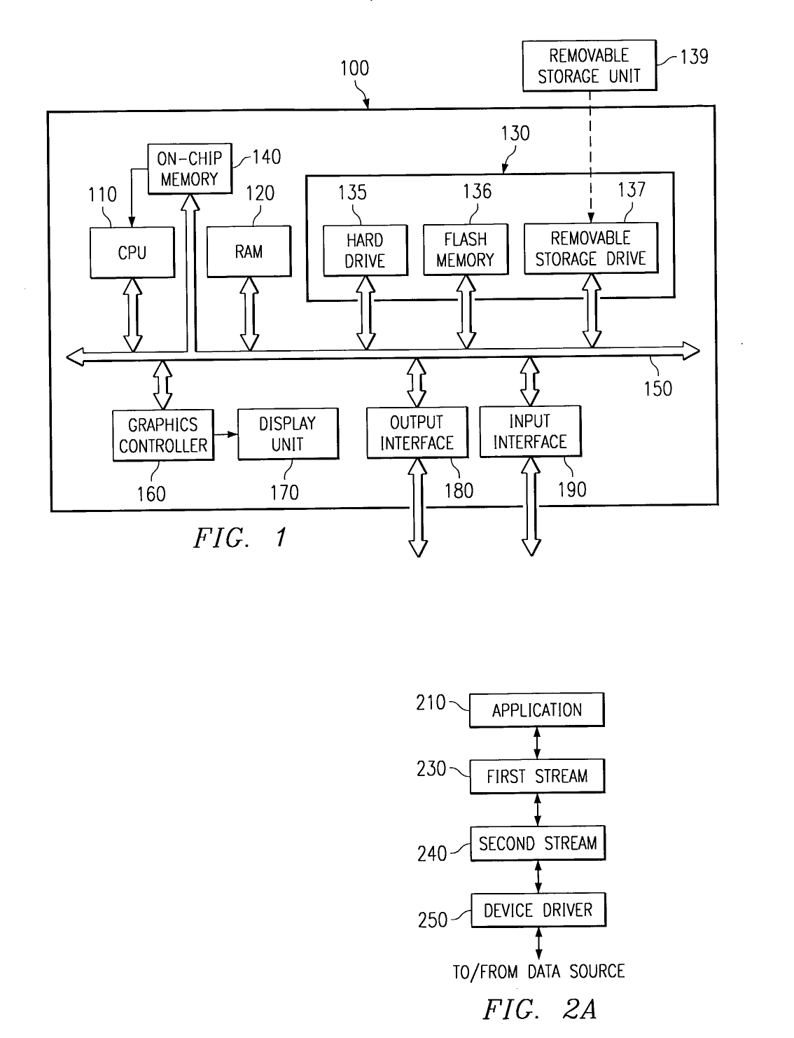

FIG. 1 is a block diagram of computer system 100 illustrating a typical environment for implementing the present invention. Computer system 100 may contain one or more processors such as central processing unit (CPU) 110, random access memory (RAM) 120, secondary memory 130, on-chip memory 140, graphics controller 160, display unit 170, output interface 180, and input interface 190. All the components except display unit 170 may communicate with each other over communication path 150, which may contain several buses as is well known in the relevant arts. The components of FIG. 1 are described below in further detail.

CPU 110 may execute instructions stored in RAM 120 to provide several features of the present invention. CPU 110 may contain multiple processing units, with each processing unit potentially being designed for a specific task. RAM 120 may receive instructions from secondary memory 130 using communication path 150. Data may be stored and retrieved from secondary memory 130 during the execution of the instructions.

Execution of the instructions can provide various features of the present invention. In general, the instructions may represent either user applications or system software. The system software is implemented to provide stack of streams for data transfers (requested by user applications). In addition, the system software enables the user application to control the manner in which memory (in RAM 120) is allocated.

On-chip memory 540 may further enhance the performance of computer system 100 as on-chip memory 540 can be implemented along with CPU 110 in a single integrated circuit or tightly cooperating integrated circuits. A stack of streams provided in accordance with an aspect of the present invention may be used to retrieve data from external devices through output interface 190.

Various features provided by appropriate implementation of the system software and the manner in which user application may use the feature are described below. The implementation of the system software and user applications will be apparent to one skilled in the relevant arts based on the disclosure provided herein.

Graphics controller 160 generates display signals (e.g., in RGB format) to display unit 170 based on data/instructions received from CPU 110. Display unit 170 contains a display screen to display the images defined by the display signals. Input interface 190 may correspond to a key-board and/or mouse, and generally enables a user to provide inputs. Display unit 170 and input interface 190 may together enable a user to develop various user applications on computer system 100.

Secondary memory 130 may contain hard drive 135, flash memory 136 and removable storage drive 137. Flash memory 136 (and/or hard drive 135) may store the software instructions (including both system software and user applications) and data, which enable computer system 100 to provide several features in accordance with the present invention.

Some or all of the data and instructions may be provided on removable storage unit 140, and the data and instructions may be read and provided by removable storage drive 137 to CPU 110. Floppy drive, magnetic tape drive, CD-ROM drive, DVD Drive, Flash memory, removable memory chip (PCMCIA Card, EPROM) are examples of such removable storage drive 137.

Removable storage unit 140 may be implemented using medium and storage format compatible with removable storage drive 137 such that removable storage drive 137 can read the data and instructions. Thus, removable storage unit 140 includes a computer usable storage medium having stored therein computer software and/or data. An embodiment of the present invention is implemented using software running (that is, executing) in computer system 100. In this document, the term “computer program product” is used to generally refer to removable storage unit 140 or hard disk installed in hard drive 135. These computer program products are means for providing software to computer system 100.

CPU 110 may retrieve the software instructions, and execute the instructions to provide various features described below in further detail.

3. Stack of Streams

FIG. 2A is diagram illustrating the manner in which a stack of streams may be used to efficiently provide data to an application. For illustration, it will be assumed that an application executing on CPU 110 requires data available from a data source (such as hard drive 135) to be transferred to on-chip memory 140 during execution of a user application. The manner in which system software provided in accordance with an aspect of the present invention can be used by the user application to retrieve the data is described below.

Broadly, device driver 250 provides a potentially blocking interface to retrieve data from hard drive 135, and may be implemented in a known way. It should be understood that data may be retrieved from external sources such as another computer over a network interface, and such implementations are also contemplated to be within the scope and spirit of several aspects of the present invention.

Second stream 240 transfers the data retrieved by device driver 250 into random access memory (RAM) 120 using a non-blocking approach. For illustration, software may initiate the transfer of data and attend to other tasks while the transfer is occurring. Similarly, first stream 230 interfaces with second stream 240 in a non-blocking manner to retrieve the data from RAM 120 to on-chip memory 140.

The user application may use the non-blocking interface provided by first stream 230 to have the data retrieved. By separating the data transfer into two streams (230 and 240), first stream 230 may be implemented using potentially pre-existing software code for second stream 240.

It should be understood that system software provided in accordance with an aspect of the present invention enables user applications to cause the data to be retrieved as described above. The manner in which a user application can interface with system software is described below.

4. Example Application Software Code

FIG. 2B depicts example software code (transferring data) contained in a user application illustrating the manner in which multiple non-blocking streams can be set up and used for data transfer. Line 260 associates an instance of device driver 250 to the variable DVR. DRIVER routine (commonly referred to as function in the relevant technology arts) can be implemented in a known way in the system software. The statement of line 265 defines (specifies) second stream 240 (STREAM2) (provided as a part of the system software) to use DVR to retrieve data. Similarly, the statement of line 266 defines first stream 230 (STREAM1) to use second stream 240 to retrieve data.

The statement at line 270 opens (activates) an instance of a stream on the STMDEV1 device. The stream is assigned to the variable (label) STM1. For conciseness, the description is provided with reference to retrieving data. However, the concepts may be applied to writing data as well.

The issue statement of line 280 initiates non-blocking data transfer using instance STM1. The issue statement requests a number of bytes specified by SIZE, and a pointer to a buffer where the data may be stored is specified by BUFP. As the issue statement is non-blocking, the user application can continue with performing other tasks (as shown by the dots of lines 281-283).

The reclaim statement of line 284 is used by the application to start accessing and using the data retrieved by first stream 230. If all the requested data is not available, the reclaim statement may be blocked until all the data becomes available. The user application may continue processing the data (or with other tasks) once the reclaim returns with the retrieved data.

Thus, a stack (two or more) non-blocking streams may be used by a user application to efficiently retrieve data. The user application generally needs to be supported by an appropriate implementation of system software. Some implementation considerations in an example system software are described below.

5. Implementation of System Software

In general, the system software needs to be implemented consistent with the syntax and semantics chosen for the various types of statements in the application code. Each statement needs to be parsed to determine various parameters related to the specific task the statement is intended to perform. The system software needs to be determined to execute the corresponding task. The implementation considerations to support the user application code of FIG. 2B are described below.

In an embodiment, the system software may be designed to receive multiple issue statements and a corresponding number of reclaim statements. A first-in-first-out (FIFO) approach may be used to associate each returned reclaim statement (completed data transfer) with the corresponding issue statement. Thus, several issue statements may be pending for each (instance of) stream. All the pending issue statements may be maintained in a queue (“issue queue”) for the stream.

There are at least three different situations when a new issue statement is received by the system software—(1) issue queue is full (i.e., number of maximum allowed outstanding issue statements is exhausted); (2) issue queue is empty; and (3) issue queue is neither empty nor full. Support generally needs to be present for all the three situations in both streams 230 and 240.

For situation (1), the new issue statement may not be accepted, and an error may be returned. For situation (2), with respect to streams which rely on lower streams, an issue statement is generated to the stream at the lower layer. On the other hand, when the issue queue is empty in second stream 240, device driver 250 may be used in a blocking manner to retrieve the data. For situation (3), the issue statement is merely added to the issue queue (in the stream received in).

In an embodiment, a separate process may be maintained to examine each issue queue, and cause data transfers in the lower streams (or device drivers) to generate issue statements (or use device driver in the case of second stream 240) to the lower stream corresponding to the issue statements in the issue queue.

Once the data transfer corresponding to each issue statement is complete, a return queue is maintained to provide the data to the corresponding reclaim statements originating from the higher layer. In an implementation, an application/layer is blocked if the data corresponding to a reclaim statement is not available. If the data is available, the reclaim statement returns immediately and the data (in the buffer) is made available for further processing.

The system software may coordinate the data transfers between various layers as described above. The coordination also typically entails buffer management, which may be performed as follows.

6. Buffer Management

A combination of approaches may be used in buffer management to efficiently provide data transfers to user applications. Some example approaches are described below.

Whenever permitted by the data transfers, the same buffer may be used to transfer data across multiple layers such that the number of copies to different buffers is minimized. Typically, a pointer to a buffer is transferred across layers to provide the data in the buffer. Such an approach may be referred to as “zero buffer copy”. Such an approach is typically possible when the buffers maintained by the layers are on the same storage medium. So instead of copying a buffer into another buffer as it is passed from layer to layer, a reference to the same buffer can be passed.

In addition, multiple buffers may be used to retrieve data related to several issue statements in parallel. By using multiple buffers, the application may operate on one buffer and the ‘system software’ can process other buffers in parallel. This is commonly referred to double-buffering. As a result, the reclaim statements from the higher layers may return quickly.

For each of the buffers used to store data, the corresponding memory space may need to be allocated such that the data intended for consumption for one entity (application/layer) is not unintentionally overwritten by some other entity. An example approach for memory management is described below.

7. Memory Management

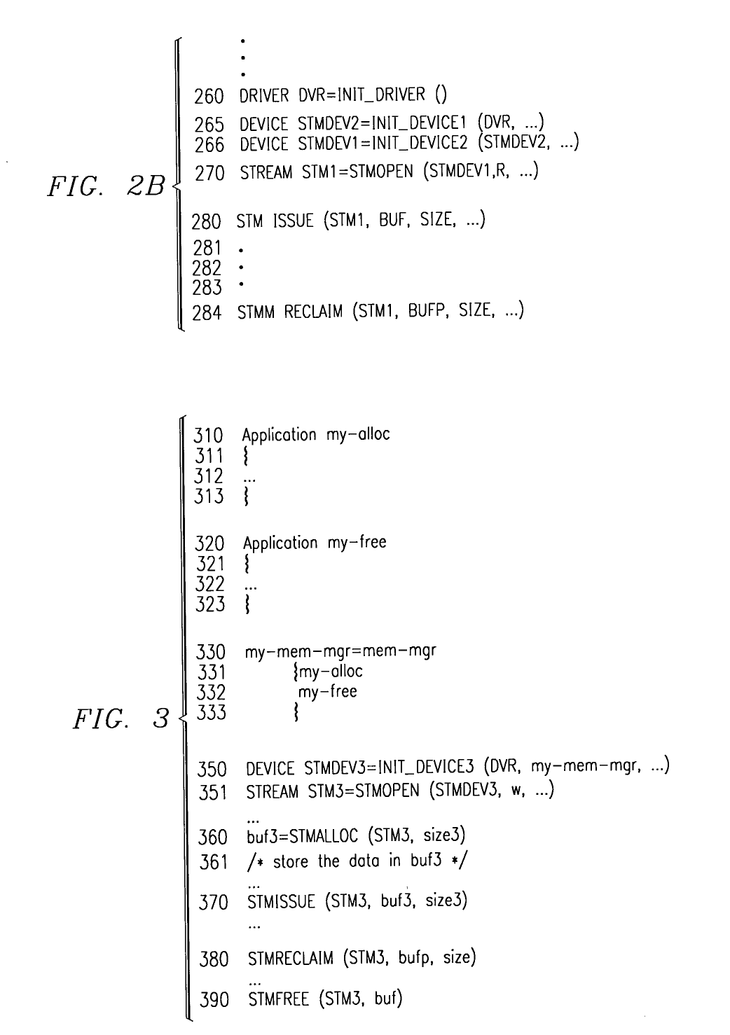

According to another aspect of the present invention, the user applications are provided greater control in managing the memory space available in RAM 120 and/or on-chip memory 140. The manner in which an application may be provided such control in securing the desired buffer space for the streaming calls is described with reference to example user application code contained in FIG. 3.

In the statements of lines 310-313 (of the user application code), a user may define the allocation logic (my-alloc) to be employed in allocating memory space. In one embodiment, the entire memory space is partitioned into multiple sub-spaces, and each sub-space is assigned a base manager. My-alloc may thus be implemented to interface with the base managers for any designed memory space.

In the statements of lines 320-323, a user may define the release logic (my-free) to free any prior allocated memory space. In general, the release logic needs to be implemented consistent with the allocation logic. For example, with reference DSPBIOS environment developed by Texas Instruments, the assignee of the subject patent application, assume that the stream buffers are to be assigned in a memory segment (sub-space) MEM1. In this scenario, my-alloc and my-free could be written as follows:

void *my-alloc (int size) { int align=4; return MEM_alloc (MEM1, size, align);}

void my-free (void *ptr, int size) {return MEM_free (MEM1, ptr, size);}

The convention for user application code and system software needs to enable the application software to use the user defined allocation and release logics. In addition, the system software needs to be implemented to provide the user applications the interface to access the basic primitives (MEM-alloc and MEM_free above) which provide the low level memory management. The user application code can then be written to provide custom higher level memory management features as desired by a programmer.

Continuing with reference to FIG. 3, in the statements of lines 330-333, my-alloc and my-free are defined to be part of a type of data structure (mem-mgr). Variable my-mem-mgr is set equal to an instance of the data-structure mem-mgr. In the statement of line 350, the variable my-mem-mgr is associated with STMDEV3 stream device. In statement 351, a stream labeled stm3 is opened for write access (using ‘w’).

In the statement of line 360, an alloc statement is issued to request a-number of bytes (size 3) for the memory space. The alloc statement is designed to use a default logic if none (i.e., no my-alloc and my-free) is specified in the statement of line 350. Once the memory space is allocated, the user application may write data into the buffer (buf3).

In statement of line 370, an issue statement is generated from the application to cause the data to be written to a device (for example using device driver 250). In statement of line 380, a reclaim statement is generated. The buffer is then released in the statement of line 390.

Thus, using the approaches of above, the present invention allows data to be provided to user applications. Some of the implementation details of an embodiment of the system software are described in the Appendix in the form of pseudo-code well known in the relevant arts. An aspect of the invention allows efficient data transfer by using a stack of non-blocking streams. Another aspect of the present invention allows for flexible memory management by providing the user applications to control the specific areas of a memory.

8. Conclusion

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents.

[image]

[image]

[image]

[image]

[image]

What is claimed is:

1. A method of transferring data from a data source to a user application, said user application being executed in a system, said method comprising:
(a) enabling a plurality of non-blocking streams to be set up between said user application and said data source; and
(b) enabling said user application to generate a statement to initiate the transfer of data from said data source using said plurality of non-blocking streams.

2. The method of claim 1, wherein said plurality of non-blocking streams comprise a stack of non-blocking streams.

3. The method of claim 2, wherein (a) comprises including a plurality of statements in said user application which cause said stack of streams to be specified and activated.

4. The method of claim 3, further comprising enabling a blocking transfer of data between a last one of said stack of non-blocking streams and said data source.

5. The method of claim 4, wherein said data source comprises one of a peripherals within said system or a source external to said system, and a first one of said stack of non-blocking streams interfaces with a driver retrieving data from said data source and a second one of said stack of non-blocking streams interfaces with said first one of said stack of non-blocking streams to provide said data to said user application.

6. The method of claim 2, further comprising using a buffer to transfer data between any two of said stack of non-blocking streams.

7. The method of claim 6, wherein said buffer is implemented using a memory space in a memory, said method further comprises:
(c) enabling said user application to control allocation of the specific portions of said memory as said memory space.

8. The method of claim 7, wherein (c) comprises including a plurality of statements representing a logic to allocate said memory space.

9. A computer readable medium carrying one or more sequences of instructions for causing transfer of data from a data source to a user application, said user application being executed in a system, wherein execution of said one or more sequences of instructions by one or more processors contained in said system causes said one or more processors to perform the action of:
(a) enabling a plurality of non-blocking streams to be set up between said user application and said data source; and
(b) enabling said user application to generate a statement to initiate the transfer of data from said data source using said plurality of non-blocking streams.

10. The computer readable medium of claim 9, wherein said plurality of non-blocking streams comprise a stack of non-blocking streams.

11. The computer readable medium of claim 2, wherein (a) comprises including a plurality of statements in said user application which cause said stack of streams to be specified and activated.

12. The computer readable medium of claim 11, further comprising enabling a blocking transfer of data between a last one of said stack of non-blocking streams and said data source.

13. The computer readable medium of claim 12, wherein said data source comprises one of a peripherals within said system or a source external to said system, and a first one of said stack of non-blocking streams interfaces with a driver retrieving data from said data source and a second one of said stack of non-blocking streams interfaces with said first one of said stack of non-blocking streams to provide said data to said user application.

14. The computer readable medium of claim 10, further comprising using a buffer to transfer data between any two of said stack of non-blocking streams.

15. The computer readable medium of claim 14, wherein said buffer is implemented using a memory space in a memory, further comprises:
(c) enabling said user application to control allocation of the specific portions of said memory as said memory space.

16. The computer readable medium of claim 15, wherein (c) comprises including a plurality of statements representing a logic to allocate said memory space.

17. A system for executing a user application which requires data from a data source, said system comprising:
means for enabling a plurality of non-blocking streams to be set up between said user application and said data source; and
means for enabling said user application to generate a statement to initiate the transfer of data from said data source using said plurality of non-blocking streams.

18. The system of claim 17, wherein said plurality of non-blocking streams comprise a stack of non-blocking streams.

19. The system of claim 18, further comprising means for enabling a blocking transfer of data between a last one of said stack of non-blocking streams and said data source.

20. The system of claim 19, further comprises a memory means providing a buffer means to transfer data between any two of said stack of non-blocking streams, wherein said buffer is implemented using a memory space in a memory, said system further comprises: means for enabling said user application to control allocation of the specific portions of said memory as said memory space.
